(19) United States
(12) Patent Application Publication
(10) Pub. No.: US 2006/0047522 A1
(43) Pub. Date: Mar. 2, 2006

(54) Method, apparatus and computer program to provide predictor adaptation for advanced audio coding (AAC) system

(75) Inventor: Juha Petteri Ojanpera, Tampere (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/928,071

(22) Filed: Aug. 26, 2004

(51) Int. Cl. G10L 21/04

(52) U.S. Cl. 704/503

(57) ABSTRACT

This invention provides a method, an apparatus and a computer program to process an audio signal. The method includes encoding an audio signal in accordance with a first type of encoding at least in part by operating a predictor to generate, in each of a plurality of audio frequency bands, an error signal such that for certain spectral bands only a residual signal is quantized. The method then transmits the encoded audio signal and, if available, related predictor data to a receiver. For a case where the receiver is compatible with a second type of encoding and is not compatible with receiving the predictor data, the method signals the receiver that the predictor data is not present. The method then further modifies the encoded audio signal to be compatible with the second type of encoding, while removing an effect of the operation of the predictor on the encoded audio signal.

### TECHNICAL FIELD

This invention relates generally to audio signal processing systems and methods and, more specifically, relates to audio content adaptation system method of a type that uses audio signal compression.

### BACKGROUND

FIG. 1 shows a conventional system where a sending device 1 transmits audio content 1A to a receiving device 2 via a channel 3. The sending device 1 may be a mobile terminal, a server located in a network, or some other device capable of transmitting the audio content 1A. The audio content 1A can be part of a larger multimedia framework, such as the Multimedia Messaging Service (MMS), or it may represent content format where only audio is present. However, the capabilities of the receiving device 2 may be such that the received audio content 1A cannot be decoded and subsequently consumed. For example, the audio format may not be supported in the receiver 2, or only a subset of the format is supported. To ensure an optimum end user experience, adaptation of the audio content to the capabilities of the receiving device is preferably performed in order to avoid any interoperability problems.

The above-mentioned adaptation may involve converting the audio format to a different format, or it may involve performing operations within the format to adapt the content to the capabilities of the receiver 2. Preferably, the adaptation is performed before sending the content to minimize the number of supported audio formats in the receiver 2. In this case, some capability negotiation is used between the sender 1 and the receiver 2 before adaptation can take place. In this manner the sender 1 can be apprised of the audio capabilities of the receiver 2, and the audio content 1A adapted accordingly.

The Advanced Audio Coding (AAC) format is gradually establishing a strong position as a high quality audio format. AAC as a coding algorithm provides a large set of coding tools, which are organized into profiles. Each profile defines a subset of the coding tools, which can be used for that particular AAC profile. The currently defined AAC profiles are: Main, LC (Low Complexity), SSR (Scalable Sampling Rate), and LTP (Long-Term Prediction). The first three profiles have been originally defined for the MPEG-2 AAC codec, whereas the LTP profile has been defined for the MPEG-4 AAC codec. However, these profiles are not fully interoperable with each other. For example, the SSR capable AAC decoder cannot decode the other profiles and vice versa. Fortunately, SSR profile has not gained much in popularity and is currently not widely used, and is not expected to be widely used in the future. The remaining three profiles (Main, LC and LTP) interoperate partly. For example, the Main and LTP profiles are both capable of decoding the LC profile, however the LC profile cannot decode the Main or LTP profiles. A primary difference between the Main and LTP profiles is the implementation of the predictor coding tool, i.e., the Main profile uses a backward adaptive lattice predictor whereas the LTP profile uses a forward adaptive pitch predictor. The computational complexity associated with the lattice predictor is approximately half of the total complexity of the AAC decoder, and this is one the main reasons why the Main profile has not been not widely used to date. For example, the AAC LC and LTP profiles are optional audio formats in the 3^{rd} Generation Partnership Project (3GPP) standardization, but the AAC Main profile is currently not specified to be used at all in 3GPP.

The LC profile is currently the most widely adopted of the AAC profiles, although it is expected that the AAC LTP content will soon start to be used more widely. For example, it is expected that some new devices will include the MPEG-4 AAC encoder, where LTP is the preferred profile. A problem is thus created, as the current existing base of devices having AAC LC profile-only decoders would be incapable of playing and consuming AAC LTP content.

One possible solution to this problem would be to simply refuse to decode LTP content and to thus ignore the end user experience. This solution is obviously unsatisfactory.

Another possible solution would be to decode the LTP content to the time domain, and then re-encode the content back to LC content. This latter approach is, however, also not satisfactory due at least in part to the heavy computational burden that is imposed on the receiver 2.

Prior to this invention, no satisfactory solution existed the problems discussed above.

### SUMMARY OF THE PREFERRED EMBODIMENTS

The foregoing and other problems are overcome, and other advantages are realized, in accordance with the presently preferred embodiments of these teachings.

This invention pertains to a method, an apparatus and a computer program to process an audio signal. The method includes encoding an audio signal in accordance with a first type of encoding at least in part by operating a predictor to generate, in each of a plurality of audio frequency bands, an error signal such that for certain spectral bands only a residual signal is quantized. The method then transmits the encoded audio signal and, if available, related predictor data to a receiver. For a case where the receiver is compatible with a second type of encoding and is not compatible with receiving the predictor data, the method signals the receiver that the predictor data is not present. The method then further modifies the encoded audio signal to be compatible with the second type of encoding, while removing an effect of the operation of the predictor on the encoded audio signal.

A decoder in accordance with an aspect of this invention processes an encoded signal encoded in accordance with a first type of encoding that uses, at least in part, a predictor to generate in each of a plurality of frequency bands an error signal, such that for certain bands only a residual signal is quantized. The decoder is compatible with a second type of encoding and is not compatible with receiving the predictor data, and uses a unit to modify the encoded audio signal to be compatible with the second type of encoding, while removing an effect of the operation of the predictor on the encoded audio signal.

In a still further aspect this invention provides a digital storage medium that stores a computer program to cause a data processor to process an audio signal that is encoded in accordance with a first type of encoding. A predictor generates, in each of a plurality of frequency bands, an error signal such that for certain bands only a residual signal is quantized. In response to a decoder being compatible with a second type of encoding and not compatible with receiving the predictor data, the computer program directs the data processor to modify the encoded audio signal to be compatible with the second type of encoding, while removing an effect of the operation of the predictor on the encoded audio signal.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is simplified diagram illustrating a conventional media content adaptation framework;

FIG. 2 is a block diagram of an AAC encoder and decoder, that is modified to operate in accordance with the adaptation method and apparatus of this invention;

FIG. 3 is a block diagram of a wireless communications system having network and mobile station elements that are a suitable embodiment but non-limiting embodiment for implementing the AAC encoder and decoder of FIG. 2; and

FIG. 4 is a logic flow diagram in accordance with an embodiment of a method of the invention.

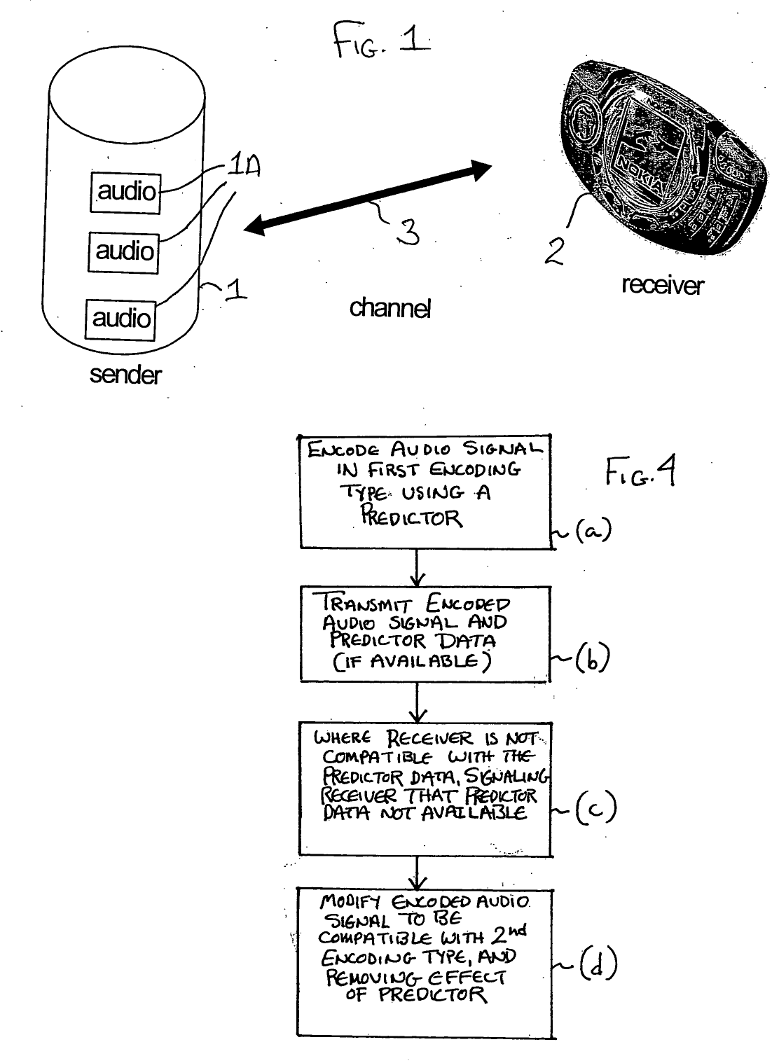

### DETAILED DESCRIPTION OF THE PREFERRED EMBODIMENTS

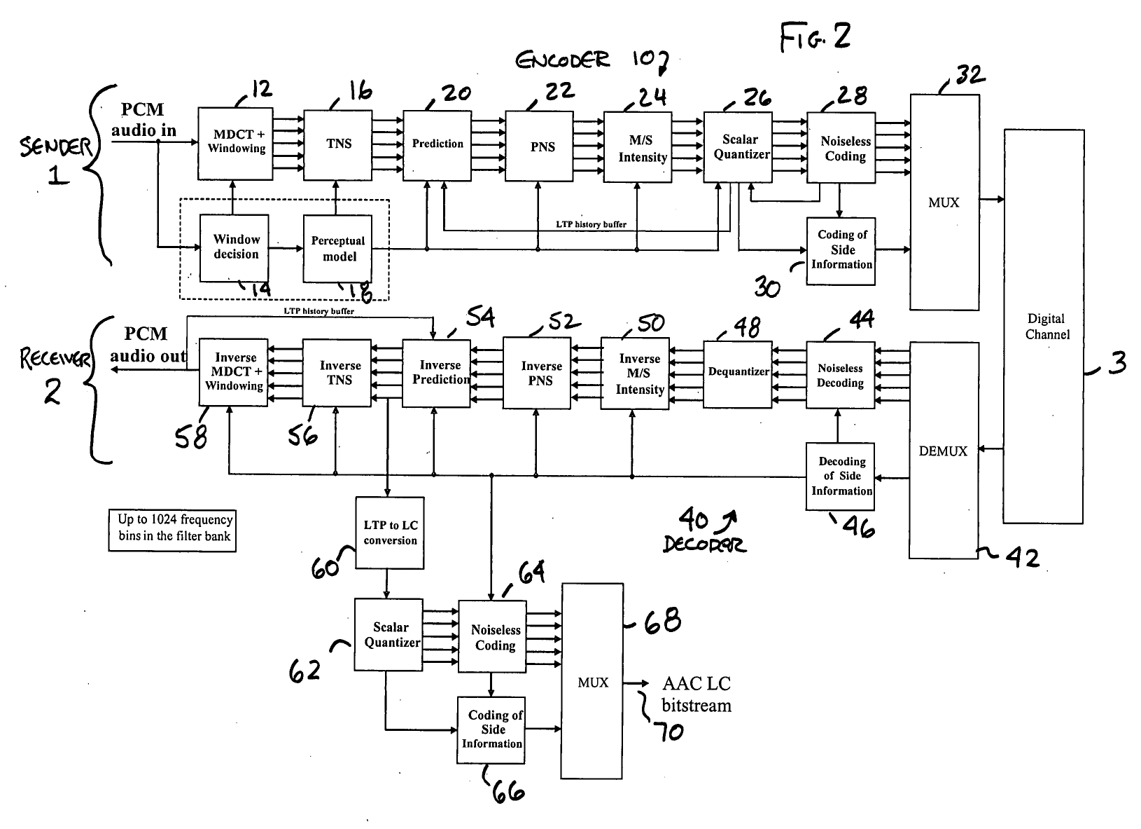

A block diagram of an AAC encoder 10 and decoder 40 is shown in FIG. 2. General reference in this regard can be had to ISO/IEC JTC1/SC29/WG11 (MPEG-2 AAC), Generic Coding of Moving Pictures and Associated Audio, Advanced Audio Coding, International Standard 13818-7, ISO/IEC, 1997; and to ISO/IEC JTC1/SC29/WG11 (MPEG-4), Coding of Audio-Visual Objects: Audio, International Standard 14496-3, ISO/IEC, 1999.

Prior to quantization at block 26, a number of coding tools can be used to modify the spectral lines in same meaningful manner. In the following paragraphs, these tools are discussed in more detail.

The Modified Discrete Cosine Transform (MDCT) and windowing block 12 operates in conjunction with a window decision block 14, and both receive the PCM audio input. The MDCT, essentially a filter bank, has dynamic window switching between lengths 2048 and 256, is used to achieve the spectral decomposition and redundancy reduction. The shorter length windows are used to efficiently handle transient signals, that is, signals whose characteristics change rapidly in time. There can be up to 1024 frequency bins in the filter bank.

The Temporal Noise Shaping (TNS) block 16 works in conjunction with the perceptual model block 18, and applies well-known linear prediction techniques in the frequency domain to shape the quantization noise in the time domain. This results in a non-uniform distribution of quantization noise in the time domain, which is an especially useful feature for speech signals.

The prediction block 20 includes a backward adaptive predictor (Main profile) that applies a second order lattice predictor to each spectral bin over each successive speech frame (e.g., each 20 msec speech frame) using previously quantized samples as an input. The adaptation function requires that all the predictors be continuously running in order to adapt the coefficients to the input signal statistics. In order to maximize the prediction gain, the difference signal is obtained on a frequency band basis. If predictable components are present within the band, the difference signal is used; otherwise that band is left unmodified. This control is implemented as a set of flags, which are transmitted to the decoder 40 along with the other predictor parameters.

The prediction block 20 also includes a Long-Term Prediction (LTP profile) function that operates to obtain the error signal for the quantizer 26 by means of a prediction error filter that operates both in the time and frequency domains. This dual-domain approach is achieved as follows. First, the predicted time domain version of the current input signal is obtained using a traditional pitch predictor. Next, the predicted time domain signal is converted to a frequency domain representation for the residual signal computation. In order to maximize the prediction gain, the difference signal is obtained on a frequency band basis. If predictable components are present within the band, the difference signal is used; otherwise that band is left unmodified. This control is implemented as a set of flags, which are transmitted to the decoder 40 along with the other predictor parameters. The LTP requires an internal decoder to obtain the reconstructed time domain samples as the prediction, and uses past time domain samples to obtain the predicted time domain signal. Further reference with this regard can be had to J. Ojanperä, M. Väänänen, Y. Lin, “Long term predictor for transform domain perceptual audio coding”, 109^{rd} AES Convention, New York 1999, Preprint 5036.

A next block in the encoder 10 is a Perceptual Noise Substitution (PNS) block 22. The PNS block 22 is used to represent noise-like components in the audio signal by transmitting only the total energy of noise-like frequency regions, and synthesizing the spectral lines randomly with the same energy at the decoder 40.

A next block in the encoder 10 provides stereo coding tools, and is represented as a M/S (Mid/Side) and/or Intensity stereo (IS) block 24. For channel pairs the MS, the IS, or both, can be used. For the case of MS-stereo the sum and the difference of the left and right channels are transmitted, whereas for Intensity stereo only one channel is transmitted. In Intensity stereo, the two-channel representation is obtained by scaling the transmitted channel according to the information sent by the encoder 10 (where the left and right channels have different scaling factors).

The next blocks in the encoder 10 are the Scalar Quantizer block 26 and the Noiseless Coding block 28. For non-uniform quantization additional noise shaping is performed via scalefactors (part of noiseless coding and scalar quantizer). A scalefactor is assigned to each frequency band. The scalefactor value is either increased or decreased to modify the signal-to-noise ratio and the bit-allocation of the band. Further coding gain is achieved by differentially Huffman coding the scalefactors. For the Huffman coding operation multiple codebooks (12) are combined with truly dynamic codebook allocation. A codebook can be assigned to be used only in a particular frequency band or it can be shared amongst neighboring bands.

Also provided is a block 30 for coding side information, which feeds its output, along with the output of the Noiseless Coding block 28, to a transmit multiplexer 32. The output of the multiplexer 32 is provided to the digital channel 3, which can be a wired or a wireless channel, or a combination of both. For example, the channel 3 may include a digital cellular communications channel.

At the decoder 40 the operations of the encoder 10 are performed in the reverse order. The received samples are demultiplexed in block 42 into the audio and side information channels, and then passed through all of the decoder tools, represented by blocks 44-58. Each decoder tool performs the reverse operation to the inputted samples to eventually yield a PCM audio output.

In accordance with preferred embodiments of this invention, the decoder 40 is modified from the conventional configuration to include, coupled to an output of the inverse prediction tool 54, an LTP to LC conversion block 60 that feeds a scalar quantizer 62. The output of the scalar quantizer 62 is provided to a noiseless decoding block 64, as well as to a side information coding block 66. The outputs of the blocks 64 and 66 are input to a multiplexer (MUX) 68, which combines these inputs and outputs, in accordance with this invention, an Advanced Audio Coding (AAC), Low Complexity (LC) bitstream 70. With regard to the following mathematical equations, the LTP to LC conversion block 60 performs operations that correspond to Eqs. 4, 5 and 6 for a mono channel, and Eqs. 7, 8, 9 and 10 for a stereo channel, and the scalar quantizer 62 performs operations that correspond to Eq. 3. The operation of the decoder blocks 60-68 when generating the AAC LC bitstream 70 is discussed in detail below.

In general, FIG. 2 shows the block diagram of an AAC codec, that is, the encoder 10 and the corresponding decoder 40. However, the basic AAC codec is modified in accordance with this invention to include the blocks 60-68 that is tightly coupled with the decoder 40, since the blocks 60-68 need parameter values from the bitstream and from various stages of decoding. It is pointed out that this invention requires no knowledge of, or connection to, the encoder 10. The encoder 10 may encode the signal in a format that it finds suitable, and this invention assumes that the encoder 10 and decoder 40 have no relationship with each other. Otherwise, it may be assumed that the encoder 10 would encode the signal so that the encoded format would match the capabilities of the decoder 40. The signal may be encoded, for example, to a file and then exchanged in various ways so that when one is finally about to decode the file one may have a decoder that is not capable of decoding the signal. The LC decoder could ignore the predictor data information that is present in the bitstream, but this would degrade the quality of the decoded signal. Also, it is typically the case that the LC decoder is not capable of ignoring the predictor data information, as it always assumes that the predictor_data_present bit is zero. However, for the case where it is not zero additional information bits will follow the flag bit, but the LC decoder is not able to read the additional information bits. The AAC standard specifies that for the LC profile no predictor data can be present and, if there is, the bitstream is invalid. During the AAC standardization process the predictor_data_present flag was specified to be present for all AAC profiles, but only for the Main and LTP profiles was it allowed to have a value ‘1’. It is instructive to keep these various points in mind when reading the ensuing detailed description of this presently preferred embodiments.

An important distinction between the LC and the LTP profiles is that the prediction module 20 is not available in the LC profile. At the bitstream level the presence of the predictor 20 is signaled using a flag bit. Table 1 is an excerpt from the MPEG-4 Audio standard showing the bitstream element syntax where this flag bit is located in the bitstream. If ‘predictor_data_present’ equals ‘1’, predictor data is present and either Main or LTP profile-specific data is read from the bitstream. If ‘predictor_data_present’ equals ‘0’, no predictor data is read from the bitstream. Thus, for the Main and LTP profiles the allowed values for the predictor flag bit are ‘0’ and ‘1’, whereas for the LC profile the predictor flag bit must always be equal to ‘0’.

TABLE 1
Bitstream syntax element for AAC predictors.

| Syntax | No. of bits |
|---|---|
| ics_info( ) | |
| { | |
| ics_reserved_bit; | 1 |
| window_sequence; | 2 |
| window_shape; | 1 |
| if(window_sequence == | |
| EIGHT_SHORT_SEQUENCE) { | |
| max_sfb; | 4 |
| scale_factor_grouping; | 7 |
| } | |
| else { | |
| max_sfb; | 6 |
| predictor_data_present; | 1 |
| if(predictor_data_present) { | |
| if(profile == Main) | |
| Read Main predictor data; | |
| else | |
| Read LTP predictor data; | |
| } | |
| } | |
| } | |

It is important to note that if the predictor-specific data is simply deleted, and the flag bit is set to ‘0’, the output signal, when decoded using only an LC-capable decoder 40, can contain severe quality artifacts.

It is further noted that the Main or LTP predictor 20 can have a significant prediction gain on multiple spectral bands in a current AAC frame. On these spectral bands only the residual signal is quantized and transmitted. Thus, in order to remove the prediction data from the bitstream, the contribution of the predictor 20 to the coded signal needs to be compensated for on a frame-by-frame basis. Only in this way can the quality of the output audio signal be preserved.

A presently preferred adaptation method for the removal of LTP predictor data from a single channel element bitstream is now explained in detail.

Let \hat{x} represent the dequantized residual signal that is passed to an LTP inverse prediction tool 54. The output signal X can then be expressed as

$$X ( sfb ) = \{ \begin{matrix}xr ( sfb ) , & if pred\_flag ( sfb ) \text{==} ' 0 ' \\ xp ( sfb ) , & otherwise\end{matrix} \\ \begin{matrix}\begin{matrix}xr ( sfb ) = & \hat{x} ( i ) , & sfb\_offset [ sfb ] \leq i < sfb\_offset [ sfb + 1 ] \\ xp ( sfb ) = & \hat{x} ( i ) + \tilde{x} ( i ) , & sfb\_offset [ sfb ] \leq i < sfb\_offset [ sfb + 1 ]\end{matrix} & ( 1 )\end{matrix}$$

where ‘pred_flag(sfb)’ is a prediction control indicating whether the residual signal is present in band ‘sfb’ or is not present, x is the predicted LTP signal, and ‘sfb_offset’ is a sample rate-dependent table describing the band boundaries of each spectral band. A technique to determine the predicted LTP signal \tilde{x} is described in detail in J. Ojanperä, M. Väänänen, Y. Lin, “Long term predictor for transform domain perceptual audio coding”, 109^{rd} AES Convention, New York 1999, Preprint 5036.

Equation (1) is repeated for 0≦sfb<mSfb, where mSfb is the maximum number of spectral bands present in the current AAC frame, as indicated in Table 1. The length of X is ‘sfb_offset(mSfb)’ and represents the signal from which LTP predictor data has been removed. A next operation is to re-quantize the signal X and to generate the output bitstream.

The dequantized signal \hat{x} is obtained as follows:

$$\begin{matrix}\hat{x} = \{ \begin{matrix}\begin{matrix}xrec ( sfb ) \cdot \\ {2}^{0.25 ( sfac ( sfb ) - 100 )} ,\end{matrix} & \begin{matrix}if \\ hCb ( sfb ) != INTENSITY\_BAND \\ and \\ hCb ( sfb ) != NOISE\_BAND\end{matrix} \\ zero\_xrec ( sfb ) , & otherwise\end{matrix} & \\ xrec ( sfb ) = sign ( {x}_{q} ( i ) ) \cdot {\vert {x}_{q} ( i ) \vert}^{4 \text{/} 3} , \\ sfb\_offset [ sfb ] \leq i < sfb\_offset [ sfb + 1 ] \\ zero\_xrec ( sfb ) = 0 , \\ sfb\_offset [ sfb ] \leq i < sfb\_offset [ sfb + 1 ] \\ sign ( a ) = \{ \begin{matrix}1 , & if a \geq 0 \\ - 1 , & otherwise\end{matrix} & ( 2 )\end{matrix}$$

Equation (2) is repeated for 0≦sfb<mSfb, where x_{q} is the quantized signal, ‘hCb(sfb)’ is the Huffman codebook number and ‘sfac(sfb)’ is the scalefactor for band ‘sfb’, respectively. A zero spectra is returned for spectral bands where either Intensity stereo or PNS (tool 22) is enabled. The corresponding decoder tool 52 reconstructs the spectral values for these bands. The presence of Intensity stereo and PNS are signaled using special codebook numbers. For example, the values 14 and 15 have been specified for Intensity stereo, and the value 13 has been specified for PNS. The quantized signal, scalefactors, and Huffman codebook numbers are all decoded from the LTP bitstream.

The re-quantization equation for the signal X is the inverse of Equation (2) as follows
xq_{LC}=└0.4054+x_{LTP}(sfb)·2^{-0.1875(sfc}^{_{—}}^{new(sfb)-100}, 0≦sfb<mSfb
x_{LTP}(sfb)=sign(X(i))·X(i)|^{3/4}, sfb_offset[sfb]≦i<sfb_offset[sfb+1] (3)
where xq_{LC} is the quantized signal for the LC profile and ‘sfac_new(sfb)’ is the scalefactor for band ‘sfb’. The scalefactors could be the same as in the LTP profile bitstream, however those particular scalefactors were originally determined for the residual signal. When the LTP contribution is added to the residual signal these scalefactor values are no longer valid from a psycho-acoustical perspective. If the goal is transparent quality, that is, the conversion itself should not degrade the signal quality, the original scalefactors need to be modified in order to also take the LTP contribution into account. The scalefactors for the re-quantization are therefore determined as follows

$$\begin{matrix}sfac\_new ( sfb ) = \{ \begin{matrix}{sf}_{LTP} ( sfb ) , & if pred\_flag ( sfb ) \text{==} ' 1 ' \\ sfac ( sfb ) , & otherwise\end{matrix} & \\ {sf}_{LTP} ( sfb ) = \{ \begin{matrix}sfac ( sfb ) - ltpSfac ( sfb ) , & if sfac ( sfb ) > 0 \\ sfac2 ( sfb ) - ltpSfac ( sfb ) , & otherwise\end{matrix} \\ where & ( 4 ) \\ ltpSfac ( sfb ) = ⌊ \frac{{log}_{10} ( energyLTP ( sfb ) )}{20 \cdot {log}_{10} ( {2}^{0.25} )} ⌋ & \\ energyLTP ( sfb ) = \frac{{\sum }_{i = sfb\_offset [ sfb ]}^{sfb\_offset [ sfb + 1 ]} ( \tilde{x} ( i ) \cdot \tilde{x} ( i ) )}{sfb\_offset [ sfb + 1 ] - sfb\_offset [ sfb ]} \\ and & ( 5 ) \\ sfac2 ( sfb ) = \{ \begin{matrix}⌊ ( global\_gain + \frac{aveSfac}{nBands} ) \cdot 0.5 ⌋ , & \begin{matrix}if \\ nBands > 0\end{matrix} \\ global\_gain , & otherwise\end{matrix} \\ nBands = {\sum }_{i = startSfb}^{endSfb} \{ \begin{matrix}1 , & if sfac ( i ) > 0 \\ 0 , & otherwise\end{matrix} & \\ aveSfac = {\sum }_{i = startSfb}^{endSfb} sfac ( i ) \\ startSfb = \{ \begin{matrix}0 , & if sfb - 2 < 0 \\ sfb - 2 , & otherwise\end{matrix} & ( 6 ) \\ endSfb = \{ \begin{matrix}mSfb - 1 , & if sfb + 2 \geq mSfb \\ sfb + 2 , & otherwise\end{matrix} & \end{matrix}$$

Equation (4) is repeated for 0≦sfb<mSfb. In general, the scalefactors are adjusted in steps of 0.75 dB (as a non-limiting example). This information and the energy of the predicted LTP signal is utilized to calculate an appropriate adjustment factor to be used in the re-quantization of the LC profile signal, as shown in Equations (4)-(6).

After obtaining the quantized signal for the LC profile, the output bitstream is generated for the single channel element based on the calculated information, that is, the scalefactors and quantized signal, and remaining unmodified bitstream information. The generation of the bitstream per se should be well understood by one skilled the art, in particular to one generally familiar with AAC encoding and specifically with the noiseless and side information modules 28 and 30 of the AAC encoder 10.

For channel pair elements, the same method as explained above is used. There are, however, certain issues that are taken into account. Specifically, these issues are related to the AAC stereo coding tools. Before re-quantization of the left and right channel samples can be performed, the forward Mid/Side (MS) matrix needs to be applied for those spectral bands where MS was enabled. Also, since prediction at the encoder 10 is performed before Intensity coding, it is not possible to restore the spectral samples for those spectral bands where both LTP and Intensity are simultaneously enabled. This condition is valid only for the right channel, as this is the channel where the Intensity coding is applied (if enabled). Therefore, the forward MS matrix is preferably adopted only if the following conditions are met:

$$\begin{matrix}{MS}_{matrix} ( sfb ) = \{ \begin{matrix}APPLY\_MS , & if tool\_test ( sfb ) \text{==} TRUE \\ SKIP\_MS , & otherwise\end{matrix} & \\ tool\_test ( sfb ) = \{ \begin{matrix}TRUE , & \begin{matrix}if {pred\_flag}_{left} ( sfb ) \text{==} ' 1 ' or \\ {pred\_flag}_{right} ( sfb ) \text{==} ' 1 ' and \\ hCb ( sfb ) != INTENSITY\_BAND \\ and ms\_mask ( sfb ) \text{==} ' 1 '\end{matrix} \\ FALSE , & otherwise\end{matrix} & ( 7 )\end{matrix}$$

where ‘ms_mask(sfb)’ is the stereo control flag for the channel pair element and ‘hCb(sfb)’ is the right channel Huffman codebook number for band ‘sfb’, respectively. Equation (7) is repeated for 0≦sfb<mSfb. The forward MS matrix is calculated as follows:

$$\begin{matrix}{X}_{LEFT} ( sfb ) = \{ \begin{matrix}M ( sfb ) , & if {MS}_{matrix} ( sfb ) \text{==} APPLY\_MS \\ L ( sfb ) , & otherwise\end{matrix} \\ {X}_{RIGHT} ( sfb ) = \{ \begin{matrix}M ( sfb ) , & if {MS}_{matrix} ( sfb ) \text{==} APPLY\_MS \\ R ( sfb ) , & otherwise\end{matrix} \\ M ( sfb ) = ( {X}_{{LTP}_{left}} ( i ) + {X}_{{LTP}_{right}} ( i ) ) \cdot 0.5 & \\ L ( sfb ) = {X}_{{LTP}_{left}} ( i ) \\ S ( sfb ) = ( {X}_{{LTP}_{left}} ( i ) - {X}_{{LTP}_{right}} ( i ) ) \cdot 0.5 \\ R ( sfb ) = {X}_{{LTP}_{right}} ( i ) \\ sfb\_offset [ sfb ] \leq i < sfb\_offset [ sfb + 1 ] & ( 8 )\end{matrix}$$

where X_{LTP}_{_{left}} is the output signal of the LTP module for the left channel and X_{LTP}_{_{right}} is the output signal of LTP module for the right channel. Equation (8) is repeated for 0≦sfb<mSfb.

Next, the scalefactors are modified. In this case Equation (4) is slightly modified to take into account the possible stereo coding tools when calculating the new scalefactors, as follows:

$$\begin{matrix}\begin{matrix}{sfac\_new}_{channel} \\ ( sfb )\end{matrix} = \{ \begin{matrix}{sf}_{LTP} ( sfb ) , & \begin{matrix}if \\ {MS}_{matrix} ( sfb ) \text{==} APPLY\_MS\end{matrix} \\ \begin{matrix}Equation \\ ( 4 )\end{matrix} , & \begin{matrix}elseif \\ {pred\_flag}_{channel} ( sfb ) \text{==} ' 1 ' \\ and \\ {hCb}_{channel} ( sfb ) != \\ INTENSITY\_BAND\end{matrix} \\ sfac ( sfb ) , & otherwise\end{matrix} & \\ {sf}_{LTP} ( sfb ) = \{ \begin{matrix}sfac ( sfb ) - ltpSfac ( sfb ) , & if sfac ( sfb ) > 0 \\ sfac2 ( sfb ) - ltpSfac ( sfb ) , & otherwise\end{matrix} & ( 9 )\end{matrix}$$

where ‘sfac2(sfb)’ is calculated according to Equation (6), and

$$\begin{matrix}ltpSfac ( sfb ) = \{ \begin{matrix}⌊ \frac{{sfac}_{LTP} \_LR}{nLTPChans} ⌋ , & if nLTPChans > 0 \\ 0 , & otherwise\end{matrix} & \\ {sfac}_{LTP} \_LR = {\sum }_{i = LEFT}^{RIGHT} \{ \begin{matrix}Equation ( 5 ) , & if {pred\_flag}_{i} ( sfb ) \text{==} ' 1 ' \\ 0 , & otherwise\end{matrix} \\ nLTPChans = {\sum }_{i = LEFT}^{RIGHT} \{ \begin{matrix}1 , & if {pred\_flag}_{i} ( sfb ) \text{==} ' 1 ' \\ 0 , & otherwise\end{matrix} & ( 10 )\end{matrix}$$

Equation (9) is repeated for 0≦sfb<mSfb and for both left and right channels. As can be seen from Equation (10), the spreading of the LTP contribution, when applying the forward MS matrix, between left and right channels is taken into account by evenly distributing the adjustment factor between these channels.

Finally, the output bitstream is generated for the channel pair element based on the calculated information, that is, the scalefactors and quantized signal for the left and right channels, respectively, and for the remaining unmodified bitstream information. As was explained above, the actual generation of the bitstream should be evident to one skilled in the art.

It should be noted that because of a feedback loop in the LTP tool of the decoder 40, the inverse TNS and filter bank tools 56 and 58 are applied when converting the LTP profile to the LC profile. As was previously noted, the LTP prediction is based on the past reconstructed time domain samples that are stored in the LTP history buffer 55. If the samples in the LTP history buffer 55 deviate significantly from the original values, the adaptation method can experience difficulty in preserving the quality at a level where no artifacts would be present in the LC profile signal.

Furthermore, the AAC standard has specified that the predictor 20 is to be used only for long blocks in both the Main and LTP profiles. In the case of short blocks no predictor data is present in the bitstream (see Table 1), and no modifications are needed for the coded signal. However, because of the feedback loop and the LTP history buffer 55, each bitstream is preferably decoded to the time domain, regardless of the block type.

For those spectral bands where no modifications are performed (that is, the quantized signal and the scalefactor remain the same), it is beneficial to not perform the re-quantization, since the output signal remains the same as the quantized LTP profile signal.

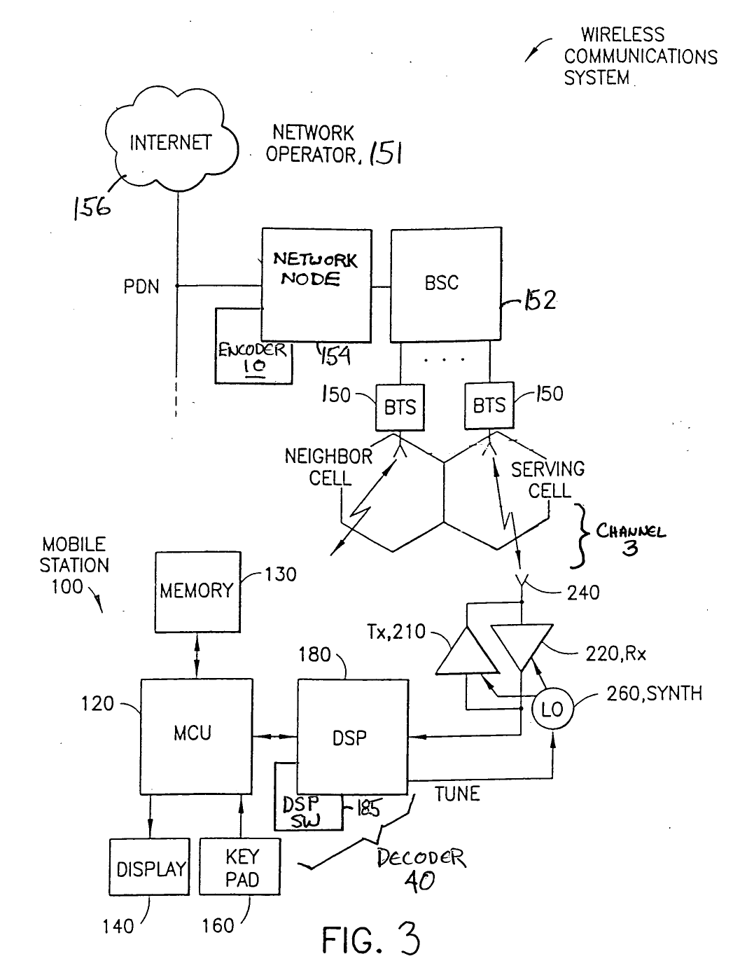

Both hardware and software implementations of this invention may be employed. However, a dedicated hardware solution (for this one function) may not be a most efficient implementation. As such, the invention may be implemented using a programmed data processor, such as a digital signal processor (DSP), or through a combination of some dedicated hardware and the DSP. Reference is now made to FIG. 3 for illustrating one suitable but non-limiting embodiment for implementing this invention. In the embodiment of FIG. 3 the AAC encoder 10 is shown implemented in a network element or node 54, while the AAC decoder 40 is shown as being implemented in a mobile station (MS 100) which could be, as non-limiting examples, a cellular telephone or a personal communicator, a music playback device having a wireless interface, a gaming device having a wireless interface, or a device that combines two or more of these functions. In other embodiments the encoder 10 could be found in the MS 100, and the decoder 40 in the network node 54 (or 52). In many cases both the network and the MS 100 will include the AAC encoder and decoder functionality.

The wireless communications system includes at least the one MS 100 and an exemplary network operator 151 having, for example, the node 154 for connecting to a telecommunications network, such as a Public Packet Data Network or PDN, at least one base station controller (BSC) 152 or equivalent apparatus, and a plurality of base transceiver stations (BTS) 150, also referred to as base stations (BSs), that transmit in a forward or downlink direction both physical and logical channels to the mobile station 100 in accordance with a predetermined air interface standard. A reverse or uplink communication path also exists from the mobile station 100 to the network operator 151.

A cell is associated with each BTS 50, where one cell will at any given time be considered to be a serving cell, while an adjacent cell(s) will be considered to be a neighbor cell.

The air interface standard can conform to any suitable standard or protocol, and may enable both voice and data traffic, such as data traffic enabling Internet 56 access and web page downloads. Audio content may also be received via the PDN.

As was noted above, in this example the network node 154 is shown as including the AAC encoder 10 of FIG. 2, although it could be located elsewhere.

The mobile station 100 typically includes a control unit or control logic, such as a microcontrol unit (MCU) 120 having an output coupled to an input of a display 140 and an input coupled to an output of a keyboard or keypad 160. The mobile station 100 may be a handheld radiotelephone, such as a cellular telephone or a personal communicator. The mobile station 100 could also be contained within a card or module that is connected during use to another device. For example, the mobile station 100 could be contained within a PCMCIA or similar type of card or module that is installed during use within a portable data processor, such as a laptop or notebook computer, or even a computer that is wearable by the user.

The MCU 120 is assumed to include or be coupled to some type of a memory 130, including a non-volatile memory for storing an operating program and other information, as well as a volatile memory for temporarily storing required data, scratchpad memory, received packet data, packet data to be transmitted, and the like. The operating program is assumed to enable the MCU 120 to execute the software routines, layers and protocols required to operate with the network operator 151, as well as to provide a suitable user interface (UI), via display 140 and keypad 160, with a user. Although not shown, a microphone and speaker are typically provided for enabling the user to conduct voice calls in a conventional manner.

The mobile station 100 also contains a wireless section that includes a DSP 180, or equivalent high speed processor or logic, as well as a wireless transceiver that includes a transmitter 200 and a receiver 220, both of which are coupled to an antenna 240 for communication with the network operator. At least one local oscillator, such as a frequency synthesizer (SYNTH) 260, is provided for tuning the transceiver. Data, such as digitized audio and packet data, is transmitted and received through the antenna 240.

In this non-limiting embodiment the DSP 180 is assumed to implement the functionality of the AAC decoder 40, and the DSP software (SW) stored in memory 185 is assumed to provide the necessary functionality to receive and decode an AAC bitstream from the AAC encoder 10, as was described above. Note that at least some of this functionality may be performed as well by the MCU 120, under control of the software stored in the memory 130.

As was stated above, in other embodiments of this invention the encoder 10 could be found in the MS 100, and the decoder 40 in the network node 154 (or 152). In many cases the network operator 151 and the MS 100 will both include the AAC encoder 10 and decoder 40 functionality.

The presently preferred adaptation method described above is suitable for use as well for Main to LC profile conversion. The method itself remains the same, and only those portions where the LTP-related information is used are replaced with corresponding Main predictor-related information. It should also be noted that the Main profile prediction uses only past dequantized spectral samples as an input to the predictor 20. Therefore, the inverse TNS and filter bank tools 56 and 58 need not be applied when converting from the Main profile to the LC profile.

Based on the foregoing description it should be appreciated that the use of this invention provides a number of advantages. Three representative advantages that are obtained by the use of this invention are as follows. The first advantage is that there is provided an efficient compressed domain LTP to LC profile conversion process, without the need to fully decompress and re-compress the LTP file. The second advantage is that the technique is not computationally expensive, making it suitable for use in terminals having limited data processing capabilities. The third advantage is that the use of this invention achieves transparent quality, that is, the adaptation does not introduce any artifacts into the converted LC content, and at the same time the required storage space is kept small.

It should be noted that while this invention finds particular utility when supporting basically the same type of terminals (e.g., cellular mobile telephones) having differing audio encoder/decoder capabilities, the use of this invention is also advantageous when interoperability is an issue between terminals made by one manufacturer and third party devices, such as digital music storage and playback devices, where only LC content is currently supported.

Based on the foregoing description it should be apparent that an aspect of this invention is to provide adaptation in order to assure interoperability between existing terminals and new terminals in order to optimize the end user experience when receiving LTP profile encoded audio content. Described herein is a novel compressed domain adaptation method for performing AAC LTP to AAC LC conversion.

This invention provides a novel compressed domain adaptation scheme for AAC audio format where the format itself remains the same, but the profile of the format is adapted to a more widely used and adopted AAC profile.

Based on the foregoing description, it can be appreciated that an aspect of this invention is a method to process an audio signal, as well as digital storage medium that stores a computer program or programs that process an audio signal in accordance with the teachings of this invention. As is shown in FIG. 4, the method includes: (a) encoding an audio signal in accordance with a first type of encoding at least in part by operating a predictor to generate, in each of a plurality of audio frequency bands, an error signal such that for certain spectral bands only a residual signal is quantized; (b) transmitting the encoded audio signal and, if available, related predictor data to a receiver; for a case where the receiver is compatible with a second type of encoding and is not compatible with receiving the predictor data, (c) signaling the receiver that the predictor data is not present; and (d) modifying the encoded audio signal to be compatible with the second type of encoding, while removing an effect of the operation of the predictor on the encoded audio signal. The blocks shown in FIG. 4 may also be visualized as a simplified block diagram of a system that includes an audio encoder that includes a predictor, a transmitter, a signaling circuit and circuitry that modifies the encoded audio signal, and that removes the effect of the operation of the predictor.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of other similar or equivalent bitstream formats, numbers of windows and frequency bins, and specific encoder/decoder tools may be attempted by those skilled in the art. However, all such and similar modifications of the teachings of this invention will still fall within the scope of this invention.

Furthermore, some of the features of the present invention could be used to advantage without the corresponding use of other features. As such, the foregoing description should be considered as merely illustrative of the principles of the present invention, and not in limitation thereof.

What is claimed is:

1. A method to process an audio signal, comprising:
encoding an audio signal in accordance with a first type of encoding at least in part by operating a predictor to generate, in each of a plurality of audio frequency bands, an error signal such that for certain spectral bands only a residual signal is quantized;
transmitting the encoded audio signal and, if available, related predictor data to a receiver;
for a case where the receiver is compatible with a second type of encoding and is not compatible with receiving the predictor data, signaling the receiver that the predictor data is not present; and
modifying the encoded audio signal to be compatible with the second type of encoding, while removing an effect of the operation of the predictor on the encoded audio signal.

2. A method as in claim 1, where the effect of the predictor is removed on an audio frame basis.

3. A method as in claim 1, where modifying includes operating the receiver to re-quantize in each frequency band a de-quantized signal so as to be compatible with a quantized signal of the second type of encoding.

4. A method as in claim 3, where re-quantizing includes using scalefactors that are adjusted to compensate for a contribution of the first type of encoding to the residual signal.

5. A method as in claim 4, where the scalefactors are adjusted in increments.

6. A method as in claim 3, further comprising generating a bitstream for the quantized signal of the second type of encoding for one of a single channel element or channel pair elements.

7. A method as in claim 6, where for channel pair elements the re-quantizing includes initially selectively adapting a forward Mid/Side matrix in those frequency bands where Mid/Side processing was applied in the transmitter.

8. A method as in claim 6, re-quantizing includes using scalefactors that are adjusted to compensate for a contribution of the first type of encoding to the residual signal, and where for channel pair elements scalefactors are adjusted so as to take into account encoder stereo processing operations.

9. A method as in claim 1, where the first type of encoding is Advanced Audio Coding using a Long-Term Prediction profile, and where the second type of encoding is Advanced Audio Coding using a Low Complexity profile.

10. A decoder for processing an encoded signal, where the signal comprises an audio signal encoded in accordance with a first type of encoding performed at least in part by operating a predictor to generate, in each of a plurality of frequency bands, an error signal such that for certain bands only a residual signal is quantized, where said decoder is compatible with a second type of encoding and is not compatible with receiving the predictor data, said decoder comprises a unit to modify the encoded audio signal to be compatible with the second type of encoding, while removing an effect of the operation of the predictor on the encoded audio signal.

11. A decoder as in claim 10, where the functional unit removes the effect of the predictor on an audio frame basis.

12. A decoder as in claim 10, comprising means to re-quantize in each frequency band a de-quantized signal so as to be compatible with a quantized signal of the second type of encoding.

13. A decoder as in claim 12, where said re-quantizing means uses scalefactors that are adjusted to compensate for a contribution of the first type of encoding to the residual signal.

14. A decoder as in claim 13, where the scalefactors are adjusted in increments.

15. A decoder as in claim 12, further comprising means for generating a bitstream for the quantized signal of the second type of encoding for one of a single channel element or channel pair elements.

16. A decoder as in claim 15, where for channel pair elements said re-quantizing means initially selectively adapts a forward Mid/Side matrix in those frequency bands where Mid/Side processing was applied.

17. A decoder as in claim 15, where said re-quantizing means using scalefactors that are adjusted to compensate for a contribution of the first type of encoding to the residual signal, and where for channel pair elements scalefactors are adjusted so as to take into account encoder stereo processing operations.

18. A decoder as in claim 10, where the first type of encoding is Advanced Audio Coding using a Long-Term Prediction profile, and where the second type of encoding is Advanced Audio Coding using a Low Complexity profile.

19. A decoder as in claim 10, said decoder comprising a part of a wireless communications device that receives the encoded signal through a radio channel.

20. A digital storage medium that stores a computer program to cause at least one data processor to process an audio signal, comprising operations of:
encoding an audio signal in accordance with a first type of encoding at least in part by operating a predictor to generate, in each of a plurality of audio frequency bands, an error signal such that for certain spectral bands only a residual signal is quantized;
transmitting the encoded audio signal and, if available, related predictor data to a receiver;
for a case where the receiver is compatible with a second type of encoding and is not compatible with receiving the predictor data, signaling the receiver that the predictor data is not present; and
modifying the encoded audio signal to be compatible with the second type of encoding, while removing an effect of the operation of the predictor on the encoded audio signal.

21. A digital storage medium that stores a computer program to cause a data processor to process an audio signal that is encoded in accordance with a first type of encoding, where a predictor generates, in each of a plurality of frequency bands, an error signal such that for certain bands only a residual signal is quantized, where in response to a decoder being compatible with a second type of encoding and not compatible with receiving the predictor data, the computer program directs the data processor to modify the encoded audio signal to be compatible with the second type of encoding, while removing an effect of the operation of the predictor on the encoded audio signal.

22. A digital storage medium as in claim 21, embodied in a device that comprises a receiver to receive the encoded audio signal from a wireless communications channel.

23. A digital storage medium as in claim 21, where the computer program directs the data processor, when modifying the encoded audio signal, to re-quantize in each frequency band a de-quantized signal so as to be compatible with a quantized signal of the second type of encoding.

24. A digital storage medium as in claim 23, where the computer program directs the data processor, when re-quantizing, to use scalefactors having values determined to compensate for a contribution of the first type of encoding to the residual signal.

25. A digital storage medium as in claim 21, where the computer program directs the data processor to generate a data stream for one of a single channel element or channel pair elements.

26. A digital storage medium as in claim 21, where the first type of encoding comprises Advanced Audio Coding that uses a Long-Term Prediction profile, and where the second type of encoding comprises Advanced Audio Coding that uses a Low Complexity profile.
